(19) United States
(12) Patent Application Publication
(10) Pub. No.: US 2026/0340168 A1
(43) Pub. Date: Oct. 29, 2026

(54) System and method for content obfuscation based on Graph-Neural Networks (GNN)-based graphs

(71) Applicant: Bank of America Corporation, Charlotte, NC (US)

(72) Inventors: George Albero, Charlotte, NC (US); Naga Vamsi Krishna Akkapeddi, Charlotte, NC (US); Maribeth Miguel Nguyen, Los Angeles, CA (US); Sakshi Bakshi, New Delhi (IN); Chandy Oommen, Lewisville, TX (US); Ratnakar D. Madduri, Charlotte, NC (US)

(21) Appl. No.: 19/191,278

(22) Filed: Apr. 28, 2025

(51) Int. Cl. G06F 21/62

(52) U.S. Cl. CPC G06F 21/6218

(57) ABSTRACT

A system to detect and obfuscate sensitive data in software code is disclosed. The system instantiates a replica of a software application and extrapolates a set of operational attributes from the replica, where the operational attributes include data sensitivity levels. The system electronically receives a request to deploy an operation on a software application. In response, the system extrapolates code lines associated with the operation and extracts metadata from the code lines, where the metadata includes context associated with the operation. The system extrapolates that the code lines include a data element that is confidential information and obfuscates the data element. The system transforms the code lines with the obfuscated data element into binary format that is executable by a processor to perform the operation. The system deploys the code in the binary format.

### TECHNICAL FIELD

The present disclosure relates generally to network communication, and more specifically to a system and method for content obfuscation based on Graph-Neural Networks (GNN)-based graphs.

### BACKGROUND

Within an organization, software applications are deployed to execute associated operations. In some cases, a software application may include or be used to access sensitive information. For example, a software application may be configured to execute an Application Programming Interface (API) call to a database where sensitive information is stored and maintained

### SUMMARY

The disclosed system, described in the present disclosure, is particularly integrated into practical applications to provide technological improvements to conventional data and network security technologies with respect to software applications that share private/confidential operations with other software applications.

Within an organization, numerous software applications may be deployed to perform designated operations. In some cases, some software applications may share one or more operations. For example, some software applications may be configured to generate documents, generate reports, generate files, validate data in files, among others. In some cases, some operations may be deployable on multiple software applications. For example, source code of an operation/logic may be maintained as an individual software entity which can be deployed on software applications, such as an add-on plugin or embedded software module, upon request.

In conventional systems, the sharing of operations across multiple software applications leads to security breaches, security vulnerabilities, and sensitive data exposure. When a first software application shares its operations with a second software application, there is a risk that a user operating the second software application may inadvertently or intentionally access operations that they are not authorized to access. As an example use case of drawbacks in the current systems, assume that a user requests to be provided access to a particular software application with specific operations (including user onboarding, generating documents, validating data in documents, etc.). In this example, the user may have an authority to access the generating document operation of the particular software applications but not the other operations of the particular software applications. Thus, if the user is provided with the software application (in its entirety), the user may be able to gain unauthorized access to sensitive operations, such as user onboarding and validating data in documents. This unauthorized access is a point of security breach and leads to data leakage, security vulnerabilities, and sensitive data exposure. Conventional systems lack the capability to dynamically create temporary, operation-specific versions of shared software applications. Instead, the conventional systems expose the entire software application, including all its operations, to any downstream software application that requests access to a specific operation of that software application.

The disclosed system is configured to provide a technological solution to these and other technical problems in conventional data security technologies. The technical advantages and improvements over the conventional techniques are described below in conjunction with certain embodiments of the disclosed system.

In some embodiments, the disclosed system provides a technological solution to the above discussed drawbacks of the conventional data security technologies by implementing a Graph-Neural Networks (GNN) based algorithm to identify sensitive portions of a software application. The disclosed system, via the GNN-based algorithm, analyzes the emulated replicas of software applications and maps the relationships between various operations within and among the software applications to extrapolate how the operations within each software application are internally intra-related and how the software applications are externally inter-connected with other software applications. By analyzing the software applications' code and data flow structure as a graph, where nodes represent operations and edges represent their relationships, the disclosed system extrapolates meaningful insight from software interactions between the operations. The disclosed system may use this information in evaluating whether a data element in code of an operation is confidential, associated with confidential information, and/or used to access confidential information. For example, if it is determined that an operation can be used to access or analyze confidential data, the system may classify the operation as handling confidential information. By mapping the operation's relationship with other parts of the software and analyzing the flow of data through the software, the disclosed system can dynamically evaluate which portions or data elements of the software application can be used to access the confidential data (e.g., are points of security vulnerabilities and sensitive data exposure). The current systems fail to capture the inter-and intra-dependencies among operations and potential vulnerabilities that arise from the complex relationships between different operations within a software application or between different software applications in a system. Conventional security technologies are limited by static, rule-based approaches that do not account for the dynamic interactions between software code and inter- and intra-dependencies among operations of software interactions. By utilizing the graph structure of the software operations, the disclosed system provides a more adaptive security solution to extrapolate and mitigate points of security vulnerabilities and sensitive data exposure that the current systems fail to capture.

The disclosed system is configured to extrapolate which operations can be exposed to a downstream software application and which operations should remain private or protected. By extrapolating which operations can be exposed and which operations cannot, those operations that should remain private are not exposed to downstream software applications, and therefore, their sensitive data is not exposed. This, in turn, leads to preventing or reducing unauthorized access to the sensitive data, data exfiltration, sensitive data exposure, etc. By preventing the exposure of private operations and their associated data, the disclosed system improves the overall data security of those operations and reduces security risks and vulnerabilities. Some downstream technical advantages of this approach include reducing the likelihood of data breaches and unauthorized access to sensitive content, which in turn, reduces the likelihood of data exfiltration, manipulation, and destruction. The downstream technical advantages of this approach further include minimizing system downtime and preventing disruptions caused by malicious activities such as ransomware. By preventing unauthorized access and mitigating malicious activities, the disclosed system allows that operations remain stable and unaffected by external threats. In other words, the disclosed system improves the underlying functionalities of the operations.

In some embodiments, a system comprises a memory operably coupled with a processor. The memory is configured to store a first software application and a second software application, wherein the first software application and the second software application share a first operation. The processor is configured to instantiate a first emulated replica of the first software application. The processor is further configured to instantiate a second emulated replica of the second software application. The processor is further configured to extrapolate, from the first emulated replica, a first set of operational attributes comprising a first set of data sensitivity levels. Each of the first set of data sensitivity levels is associated with a respective operation within the first emulated replica. The first operation is associated with a first data sensitivity level. The first data sensitivity level is more than a threshold level indicating that the first operation comprises confidential information. The processor is further configured to extrapolate, from the second emulated replica, a second set of operational attributes comprising a second set of data sensitivity levels, wherein each of the second set of data sensitivity levels is associated with a respective operation within the second emulated replica. The processor is further configured to electronically receive, from a computing device, a request to deploy the first operation on a third software application. In response to electronically receiving the request, the processor is further configured to extrapolate a set of code lines associated with the first operation. The processor is further configured to extract, from the set of code lines based at least in part upon the first set of operational attributes and the second set of operational attributes, metadata associated with the first operation, the metadata comprising context associated with the first operation. The processor is further configured to extrapolate, based at least in part upon the metadata, that the set of code lines comprises a data element that is the confidential information. The processor is further configured to obfuscate the data element, comprising encrypting the data element into a decrypted format. The processor is further configured to transform code comprising the set of code lines with the obfuscated data element into binary format, wherein the code in the binary format is executable by the processor to perform the first operation. The processor is further configured to deploy the code in the binary format to a computing device from which the request is received.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to detect and obfuscate sensitive data in software code;

FIG. 2 illustrates an example operational flow of the system of FIG. 1 to detect and obfuscate sensitive data in software code; and

FIG. 3 illustrates an example flow chart of a method of the system of FIG. 1 to detect and obfuscate sensitive data in software code.

### DETAILED DESCRIPTION

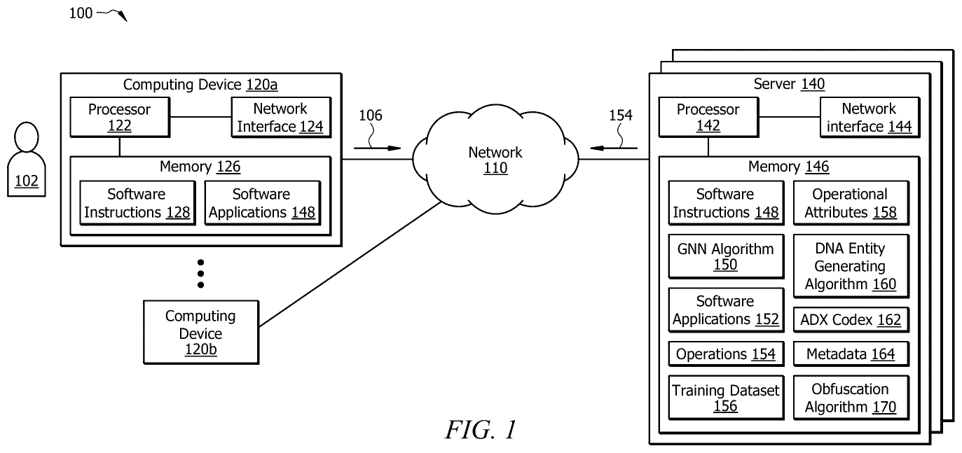

As described above, previous technologies fail to provide efficient and reliable solutions for efficiently and effectively detecting and obfuscating sensitive data in software code and generating special-purpose software code with the obfuscated data. Embodiments of the present disclosure and its advantages may be understood by referring to FIGS. 1 through 3. FIGS. 1 through 3 are used to describe systems and methods for efficiently and effectively detecting and obfuscating sensitive data in software code and generating special-purpose software code with the obfuscated data, according to some embodiments.

### System Overview

FIG. 1 illustrates an embodiment of a system 100 that is generally configured to detect and obfuscate sensitive data in software code and generate special-purpose software code (with the obfuscated sensitive data) using Graph Neural Network (GNN)-based graph structures, according to some embodiments. In some embodiments, the system 100 comprises a server 140 communicatively coupled with one or more computing devices 120a-b via a network 110. The network 110 enables communication among the components of the system 100. Each of the computing devices 120a-b may be used by users to communicate with other devices, such as the server 140. The server 140 is configured to detect and obfuscate sensitive data in software code and generate special-purpose software code with the obfuscated sensitive data. In other embodiments, system 100 may not have all of the components listed and/or may have other elements instead of, or in addition to, those listed above.

In general, the disclosed system 100 provides technological improvements to conventional data and network security technologies with respect to software applications that share private/confidential operations with other software applications. Within an organization, numerous software applications may be deployed to perform designated operations. In some cases, some software applications may share one or more operations. For example, some software applications may be configured to generate documents, generate reports, generate files, validate data in files, among others. In some cases, some operations may be deployable on multiple software applications. For example, source code of an operation/logic may be maintained as an individual software entity which can be deployed on software applications, such as an add-on plugin or embedded software module, upon request.

In conventional systems, the sharing of operations across multiple software applications leads to security breaches, security vulnerabilities, and sensitive data exposure. When a first software application shares its operations with a second software application, there is a risk that a user operating the second software application may inadvertently or intentionally access operations that they are not authorized to access. As an example use case of drawbacks in the current systems, assume that a user requests to be provided access to a particular software application with specific operations (including user onboarding, generating documents, validating data in documents, etc.). In this example, the user may have an authority to access the generating document operation of the particular software applications but not the other operations of the particular software applications. Thus, if the user is provided with the software application (in its entirety), the user may be able to gain unauthorized access to sensitive operations, such as user onboarding and validating data in documents. This unauthorized access is a point of security breach and leads to data leakage, security vulnerabilities, and sensitive data exposure. Conventional systems lack the capability to dynamically create temporary, operation-specific versions of shared software applications. Instead, the conventional systems expose the entire software application, including all its operations, to any downstream software application that requests access to a specific operation of that software application.

The disclosed system 100 is configured to provide a technological solution to these and other technical problems in conventional data security technologies. The technical advantages and improvements over the conventional techniques are described below in conjunction with certain embodiments of the disclosed system.

In some embodiments, the disclosed system 100 provides a technological solution to the above discussed drawbacks of the conventional data security technologies by implementing a GNN-based algorithm 150 to identify sensitive portions of a software application 152. The disclosed system 100, via the GNN-based algorithm 150, analyzes the emulated replicas 210 of software applications 152 and maps the relationships between various operations 154 within and among the software applications 152 to extrapolate how the operations within each software application 152 are internally intra-related and how the software applications 152 are externally inter-connected with other software applications. By analyzing the software applications' code and data flow structure as a graph, where nodes represent operations and edges represent their relationships, the disclosed system 100 extrapolates meaningful insight from software interactions between the operations 154. The disclosed system 100 may use this information in evaluating whether a data element in code of an operation is confidential, associated with confidential information, and/or used to access confidential information. For example, if it is determined that an operation 154 can be used to access or analyze confidential data, the system 100 may classify the operation 154 as handling confidential information. By mapping the operation's relationship with other parts of the software and analyzing the flow of data through the software, the disclosed system 100 can dynamically evaluate which portions or data elements of the software application can be used to access the confidential data (e.g., are points of security vulnerabilities and sensitive data exposure). The current systems fail to capture the inter-and intra-dependencies among operations 154 and potential vulnerabilities that arise from the complex relationships between different operations within a software application or between different software applications in a system. Conventional security technologies are limited by static, rule-based approaches that do not account for the dynamic interactions between software code and inter-and intra-dependencies among operations 154 of software interactions. By utilizing the graph structure of the software operations, the disclosed system 100 provides a more adaptive security solution to extrapolate and mitigate points of security vulnerabilities and sensitive data exposure that the current systems fail to capture.

The disclosed system 100 is configured to extrapolate which operations can be exposed to a downstream software application and which operations should remain private or protected. By extrapolating which operations can be exposed and which operations cannot, those operations that should remain private are not exposed to downstream software applications, and therefore, their sensitive data is not exposed. This, in turn, leads to preventing or reducing unauthorized access to the sensitive data, data exfiltration, sensitive data exposure, etc. By preventing the exposure of private operations and their associated data, the disclosed system 100 improves the overall data security of those operations and reduces security risks and vulnerabilities. Some downstream technical advantages of this approach include reducing the likelihood of data breaches and unauthorized access to sensitive content, which in turn, reduces the likelihood of data exfiltration, manipulation, and destruction. The downstream technical advantages of this approach further include minimizing system downtime and preventing disruptions caused by malicious activities such as ransomware. By preventing unauthorized access and mitigating malicious activities, the disclosed system 100 allows that operations 154 remain stable and unaffected by external threats. In other words, the disclosed system 100 improves the underlying functionalities of the operations 154.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a Local Area Network (LAN), a Wide Area Network (WAN), a Metropolitan Area Network (MAN), a Personal Area Network (PAN), a Wireless PAN (WPAN), an overlay network, a Software-Defined Network (SDN), a Virtual Private Network (VPN), a mobile telephone network (e.g., cellular networks, such as 4G or 5G), a Plain Old Telephone (POT) network, a wireless data network (e.g., Wi-Fi, WiGig, WiMAX, etc.), a Long-Term Evolution (LTE) network, a Universal Mobile Telecommunications System (UMTS) network, a Peer-to-Peer (P2P) network, a Bluetooth network, a Near-Field Communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example Computing Device

Each computing device 120 (e.g., each of computing devices 120a-n) may generally be any device that is configured to process data and interact with users. Examples of the computing device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by users. The users 102 may use the computing devices 120 to do various operations, such as data processing, data communication, etc.

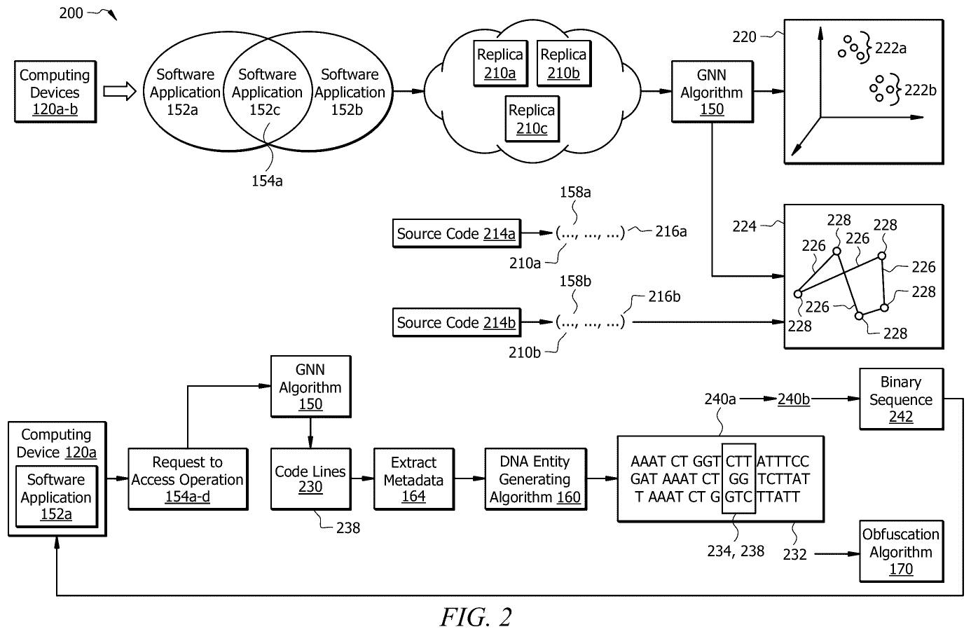

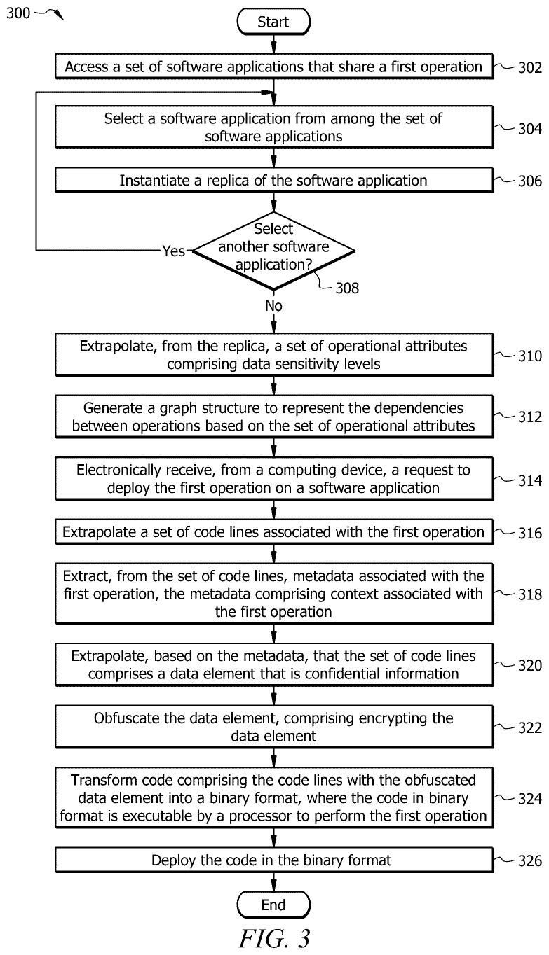

The computing device 120 includes a processor 122 in signal communication with a network interface 124 and a memory 126 configured to perform any of the functions or actions of the computing device 120 described herein. The computing device 120 is configured to communicate with other devices and components of the system 100 via the network 110. Processor 122 comprises one or more processors. The processor 122 is any electronic circuitry, including, but not limited to, state machines, one or more Central Processing Unit (CPU) chips, logic units, cores (e.g., a multi-core processor), Field-Programmable Gate Arrays (FPGAs), Application-Specific Integrated Circuits (ASICs), or Digital Signal Processors (DSPs). For example, one or more processors may be implemented in cloud devices, servers, virtual machines, and the like. The processor 122 may be a programmable logic device, a microcontroller, a microprocessor, or any suitable number and combination of the preceding. The one or more processors are configured to process data and may be implemented in hardware or software. For example, the processor 122 may be 8-bit, 16-bit, 32-bit, 64-bit, or of any other suitable architecture. The processor 122 may include an Arithmetic Logic Unit (ALU) for performing arithmetic and logic operations. The processor 122 may register the supply operands to the ALU and store the results of ALU operations. The processor 122 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128) to perform the operations of the computing device 120 described herein. In this way, processor 122 may be a special-purpose computer designed to implement the functions disclosed herein. In an embodiment, the processor 122 is implemented using logic units, FPGAs, ASICs, DSPs, or any other suitable hardware. The processor 122 is configured to operate as described in FIGS. 1-3. For example, the processor 122 may be configured to perform one or more operations of the operational flow 200 as described in FIG. 2, and one or more operations of the method 300 as described in FIG. 3.

Network interface 124 is configured to enable wired and/or wireless communications. The network interface 124 may be configured to communicate data between the computing device 120 and other devices, systems, or domains. For example, the network interface 124 may comprise an NFC interface, a Bluetooth interface, a Zigbee interface, a Z-wave interface, a Radio-Frequency Identification (RFID) interface, a Wi-Fi interface, a Local Area Network (LAN) interface, a Wide Area Network (WAN) interface, a Metropolitan Area Network (MAN) interface, a Personal Area Network (PAN) interface, a Wireless PAN (WPAN) interface, a modem, a switch, and/or a router. The processor 122 may be configured to send and receive data using the network interface 124.

The memory 126 may be a non-transitory computer-readable medium. The memory 126 may be volatile or non-volatile and may comprise Read-Only Memory (ROM), Random-Access Memory (RAM), Ternary Content-Addressable Memory (TCAM), Dynamic Random-Access Memory (DRAM), and/or Static Random-Access Memory (SRAM). The memory 126 may include one or more of a local database, a cloud database, a Network-Attached Storage (NAS), etc. The memory 126 comprises one or more disks, tape drives, or solid-state drives, and may be used as an overflow data storage device, to store programs when such programs are selected for execution, and to store instructions and data that are read during program execution. The memory 126 may store any of the information described in FIGS. 1-3 along with any other data, instructions, logic, rules, or code operable to implement the function(s) described herein when executed by processor 122. For example, the memory 126 may store software instructions 128, software applications 152, and/or any other data or instructions described herein. The software instructions 128 may comprise any suitable set of instructions, logic, rules, or code operable to execute the processor 122 and perform the functions described herein, such as some or all of those described in FIGS. 1-3. The computing device 120b includes the same or substantially similar components as the computing device 120a. For brevity, the internal components of the other computing device 120b are not illustrated in FIG. 1.

### Example Server

The server 140 generally includes a hardware computer system. In certain embodiments, the server 140 may be implemented by a cluster of computing devices, such as virtual machines in server farms within data centers. For example, the server 140 may be implemented by a plurality of computing devices using distributed computing and/or cloud computing systems in a network. In certain embodiments, the server 140 may be configured to provide services and resources (e.g., data and/or hardware resources as described herein, etc.) to other components and devices.

The server 140 may comprise a processor 142 operably coupled with a network interface 144 and a memory 146. The processor 142 comprises one or more processors. The processor 142 is any electronic circuitry, including, but not limited to, state machines, one or more CPU chips, logic units, cores (e.g., a multi-core processor), FPGAs, ASICs, or DSPs. For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an ALU for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the server 140 described herein. In this way, the processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 as described in FIG. 2, and one or more operations of the method 300 as described in FIG. 3.

The network interface 144 is configured to enable wired and/or wireless communications. The network interface 144 may be configured to communicate data between the server 140 and other devices, systems, or domains. For example, the network interface 144 may comprise an NFC interface, a Bluetooth interface, a Zigbee interface, a Z-wave interface, a Radio-Frequency Identification (RFID) interface, a Wi-Fi interface, a Local Area Network (LAN) interface, a Wide Area Network (WAN) interface, a Metropolitan Area Network (MAN) interface, a Personal Area Network (PAN) interface, a Wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise Read-Only Memory (ROM), Random-Access Memory (RAM), Ternary Content-Addressable Memory (TCAM), Dynamic Random-Access Memory (DRAM), and/or Static Random-Access Memory (SRAM). The memory 146 may include one or more of a local database, a cloud database, a Network-Attached Storage (NAS), etc. The memory 146 comprises one or more disks, tape drives, or solid-state drives, and may be used as an overflow data storage device, to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software instructions 148, GNN algorithm 150, Deoxyribonucleic (DNA) entity generating algorithm 160, software applications 152, operations 154, operational attributes 158, metadata 164, training dataset 156, Adaptive DNA Storage (ADS) Codex 162, and obfuscation algorithm 170, and/or any other data or instructions. The software instructions 148 may comprise any suitable set of instructions, logic, rules, or code operable to execute the processor 142 and perform the functions described herein, such as some or all of those described in FIGS. 1-3.

The Graph Neural Networks (GNN) algorithm 150 may be implemented by the processor 142 executing the software instructions 148 and is generally configured to analyze and process the structure and relationships of the content of the software applications 152 as a graph structure that includes nodes connected with edges. The nodes of the graph structure may represent operations 154 of the software applications 152 and edges may represent their interconnections. In some embodiments, the GNN algorithm 150 may be implemented by a Convolutional Neural Network (CNN), among other graph-based neural network algorithms. The GNN algorithm 150 may be implemented by a plurality of neural network layers, including convolutional layers, recurrent layers, transformer layers, and attention layers. In some embodiments, the GNN algorithm 150 may implement unsupervised, semi-supervised, or supervised machine learning techniques to classify operations.

In some embodiments, the GNN algorithm 150 may determine the classification of each operation 154 based on its data sensitivity level, access requirement, and training dataset 156, such as in to classes: public or private (protected) operations. In this process, the GNN algorithm 150 may extract a set of operational features from each software application 152 and its operations 154. The operational features may include metadata 1564, functionality descriptions, data dependencies, inter-functional relationships, among others, with respect to an associated operation 154. The extracted operational features are compared with the features from the training dataset 156, which contains labeled examples of public and private operations.

The GNN algorithm 150 may be trained by the training dataset 156, which includes a set of software application's operations 154, their associated metadata 1564, and labeled classifications (e.g., public or private). During training, the GNN algorithm 150 extracts operational attributes or features from each operation 154, such as metadata 164, including data dependencies, and inter-functional relationships, and generates embedding vectors comprising numerical values to represent the operations 154 in a vector space. The GNN algorithm 150 determines the similarity between operations 154 by determining distances (e.g., cosine similarity, Euclidean distance) between their embedding vectors and clusters them in the vector space based on their classifications.

During the testing phase, the GNN algorithm 150 uses the intelligence learned from the training phase to classify operations 154 within software applications 152 as public or private. The GNN algorithm 150 may be refined through a backpropagation process by adjusting the weights and biases of its neural network layers to improve classification prediction accuracy. The GNN algorithm 150 may be deployed as an inference model that continuously generates embedding vectors for new operations 154 and compares them to the learned clusters in the vector space.

The DNA entity generating algorithm 160 may be implemented by the processor 142 executing the software instructions 148 and is generally configured to convert the metadata 164 (e.g., in binary format, compiled code format, etc.) of an operation 154 into a DNA strand format using the ADS codex 162. In some embodiments, the DNA entity generating algorithm 160 may be implemented by a plurality of neural network layers, including convolutional layers, recurrent layers, transformer layers, and attention layers. In some embodiments, the DNA entity generating algorithm 160 may be implemented by unsupervised, semi-supervised, or supervised machine learning techniques. In some embodiments, the DNA entity generating algorithm 160 may utilize the ADS codex 162, a software codec that translates metadata 1564 into DNA data structure that includes a string of letter alphabet nucleotides (A, T, C, and G) which represent the four types of nitrogen bases of an DNA strand, including Adenine (A), Thymine (T), Guanine (G), and Cytosine (C). The DNA data structure occupies less space than metadata 1564 in binary format. By encoding the metadata 1564 of an operation 154 into a DNA data structure, the same data can be represented in less memory storage. Thus, the memory utilization of the system is increased.

Further, the DNA data structure provides a more secure medium to maintain the operations 154's metadata 1564 because it provides features, such as high-density storage, encryption encoding, and resistance to tampering. The DNA entity generating algorithm 160 may be provided with the metadata 1564 of an operation 154 and is asked to convert it into a DNA data structure.

The DNA entity generating algorithm 160 may use the ADS codex 162 to map the metadata 1564 to a sequence of letters with A, T, C, and G to encode the metadata 1564 into the DNA data structure. The ADS codex 162 may include a set of encoding and decoding rules, mapping algorithms, hash maps, and libraries configured to facilitate the bidirectional conversion between operation 154's metadata 1564 (e.g., in binary form) and DNA nucleotide sequences. The ADS codex 162 may further include software instructions and algorithms for data encryption and anonymization. The encoding rules of the ADS codex 162 may be derived from established bioinformatics protocols that map binary data (0s and 1s) to the nucleotide alphabets (A, T, C, and G). The libraries of the ADS codex 162 may be built using open-source bioinformatics frameworks, such as Biopython or BioJava, which provide functions for DNA sequence manipulation, analysis, and storage. The encryption algorithms of the ADS codex 162 may include Advanced Encryption Standard (AES) or Rivest-Shamir-Adleman (RSA) encryption modules, among others. The server 140 may compile the ADS codex 162 and feed it to the DNA entity generating algorithm 160 to perform its operations.

The software application 152 may be a mobile, web, or software application that is associated with source code configured to perform designated operations 154. In some examples, the operations 154 may include various technical processes, such as generating documents, generating reports, generating files, validating data in files, transforming data with a data structure to another data structure, orchestrating data workflows, among others. The obfuscation algorithm 170 may be implemented by the processor 142 executing software instructions 148 and is generally configured to encrypt, modify, scramble, or otherwise obscure data associated with one or more operations 154. In some embodiments, the obfuscation algorithm 170 may include various techniques for obfuscating data, such as hashing, encryption, tokenization, or noise generating and injection, randomization, AES or RSA encryption modules.

The obfuscation algorithm 170 may selectively obfuscate or transform portions of the source code of an operation that is determined to include or be associated with confidential content. The obfuscation algorithm 170 may preserve the overall functionality of an operation 154 while reducing the probability that the confidential content is not exposed. A specific technique of the obfuscation algorithm 170 may be implemented based on the data sensitivity indicator identified in the associated metadata 164. For example, if the data sensitivity indicator is more than a threshold (e.g., more than 8 out 10, more than 9 out 10), the server 140 may execute a more advanced and complex encryption or tokenization method of the obfuscation algorithm 170. Similarly, if the data sensitivity indicator is less than a threshold (e.g., less than 5 out 10, less than 4 out 10), the server 140 may execute a less complex method of the obfuscation algorithm 170.

### Operational Flow for Detecting and Obfuscating Sensitive Data in Code

FIG. 2 illustrates an example operational flow 200 of system 100 of FIG. 1 for content obfuscation using GNN-based graphs, according to some embodiments. Within an organization, some software applications 152 may share certain operations 154. In the example of FIG. 2, the software applications 124a, 152b, and 152c may share the operations 154a. In operation, the system may analyze and process the shared operations 154a to determine whether they need to be classified as private or public and use this information to obfuscate operations as needed. In some embodiments, the software applications 152a-c may be deployed on one or more computing devices 120 and/or server 140.

The server 140 may access the software applications 152a-c and instantiate an emulated replica 210 for each software application 152. For example, the server 140 may instantiate the first emulated replica 210a of the first software application 152a, the second emulated replica 210b of the second software application 152b, and the third emulated replica 210c of the third software application 152c. In some embodiments, instantiating a replica 210 (e.g., any of the replicas 210a-c) of a software application 152 (e.g., any of the software applications 152a-c) may include accessing source code associated with the software application 152, loading the source code into a virtual or emulated environment in a cloud system, and executing the source code.

The replica 210 of a software application 152 may be a virtual representation of the software application 152 that is configured to emulate the operations 154 of the software application 152. The replicas 210 may be deployed on a server farm, cloud-based containers that include servers 140. By instantiating a replica 210, the system enables the analysis and exposure of specific software applications 152 while maintaining the security of the original software applications 152. The server 140 may instantiate any number of replicas 210 for any number of software applications 152.

### Classifying Operations of Software Applications

In response to instantiating the replicas 210, the server 140 (e.g., via the GNN algorithm 150) may extrapolate, from each replica 210, a set of operational attributes 158. Each set of operational attributes 158 for a respective operation 154 in a replica 210, may include a set of data sensitivity levels, where each data sensitivity level corresponds to the sensitivity classification of data handled by an associated operation. Each of the sets of data sensitivity levels is associated with a respective operation within the first emulated replica 210. In some embodiments, data sensitivity levels may range from publicly accessible information (e.g., minimum confidentiality) to highly confidential information (e.g., subject to regulatory or proprietary constraints). Each set of operational attributes 158 for a respective operation 154 in a replica 210, may include information that indicates dependencies among operations 154, such as a direct or indirect reliance of one operation on another for input data, function calls, authentication tokens, among others. Each set of operational attributes 158 for a respective operation 154 in a replica 210, may include a data flow that indicates the logical path by which data traverses from an initial input source, through intermediate processing layers, to an output destination. Each set of operational attributes 158 for a respective operation 154 in a replica 210, may include one or more communication protocols for interacting with software components, hardware components, other operations 154, other software applications 152, external devices, among others. In some cases, the communication protocol may be an Application Programming Interface (API) protocol that configures request and response formats, endpoint structures, and any authentication measures required to invoke a given operation.

In the example of FIG. 2, the operation 154a may be associated with a first data sensitivity level. If the server 140 determines that the first data sensitivity level is more than a threshold level (e.g., more than 5 out 10, 7 out 10, etc.), it may be an indication that the operation 154 a comprises confidential information. For example, the server 140 may extrapolate the operational attributes 158a from the source code 214a of the replica 210a and operational attributes 158b from the source code 214b of the replica 210b. In this process, for each replica 210, the GNN algorithm 150 via its neural networks may analyze the source code 214 of the replica 210 by code analysis techniques, text analysis techniques, word segmentation and tokenization, code line segmentation and tokenization, sentence segmentation and tokenization, among others. These techniques break down the source code into smaller portions, such as functions, variables, logic blocks, and converts them into structured data so that the GNN algorithm 150 may extrapolate meaningful information. For example, the GNN algorithm 150 may extrapolate operational attributes 158, such as function names, input-output parameters, data dependencies, and control flow structures from the source code 214.

The GNN algorithm 150 may represent the operational attributes 158 as embedding vectors 216, which are numerical representations that capture the semantic meaning of each operation 154, data sensitivity levels, and the structural relationships between and among the operational attributes 158 and operations 154. The embedding vectors 216 (e.g., embedding vectors 216a-b) are generated by mapping the extracted operational attributes 158 into a high-dimensional vector space, where similar operations 154 are positioned closer together based on their attributes and relationships and form a dense cluster in the vector space 220. For example, the GNN algorithm 150 may generate the embedding vector 216a to represent the operational attributes 158a associated with the source code 214a of the software application 152a and the embedding vector 216b to represent the operational attributes 158b associated with the source code 214b of the software application 152b. The GNN algorithm 150 may classify the operations 154 in the vector space 220 into clusters, such as public cluster 222b and private cluster 222a. To this end, the GNN algorithm 150 may compare each embedding vector 216a-b to embedding vectors associated with previously classified operations 154 in the training dataset 156.

The GNN algorithm 150 may determine the distance (e.g., cosine similarity, Euclidean distance) between each embedding vector 216a-b and the embedding vectors associated with previously classified operations 154 in the training dataset 156 to determine their similarities and assign them to the appropriate cluster 222. For example, if the embedding vector 216a is within a threshold distance from a center of the private cluster 222a, the corresponding operation 154a is classified as private. In another example, if the embedding vector 216a is within a threshold distance from a center of the public cluster 222b, the corresponding operation 154a is classified as public.

The GNN algorithm 150 may use k-means clustering or other clustering techniques to organize the embedding vectors 216a-b into distinct clusters, such as the private cluster 222a and the public cluster 222b, within the vector space 220. In the example of FIG. 2, the dots in the private cluster 222a may represent operations 154 that are determined should be private and the dots in the public cluster 222b may represent operations 154 that are determined can be public. For example, private operations 154 may include operations that handle Personally Identifiable Information (PII), confidential information, or sensitive information. In another example, the public operations 154 may include operations that handle non-sensitive data, general reporting functions that aggregate and display non-confidential data, etc.

The GNN algorithm 150 may generate a graph structure 224 that includes edges 226 and nodes 228 by analyzing the relationships and dependencies between the operations 154. Each node 228 may represent an individual operation 154 of a replica 210, along with its metadata, functionality, and associated attributes 158. Each edge 226 may represent the relationships and interactions between the operations 154, such as data flow, dependencies, or functional connections. Each given pair of nodes 228 may be connected via a respective edge 226 that represents the relationship and interactions between the given pair of nodes 228. By constructing the graph structure 224, the GNN algorithm 150 can model the complex interconnections within each software application 152 and among the software applications 152 to enable their analysis based on their role and relationships as indicated by their operations 154.

The GNN algorithm 150 may analyze the graph structure 224 to identify a subgraph that indicates an operation 154 and one or more dependent operations 154 as indicated by their connecting edges 226. The GNN algorithm 150 may utilize the graph structure 224 in extracting the metadata 164 from any operation 154.

### Obfuscating Sensitive Content

The server 140 may obfuscate sensitive content associated with an operation 154a. For example, assume that the server 140 electronically receives a request 106, from the computing device 120d, to deploy the operation 154a on a software application 152d. For example, assume that a user operating the computing device 120a may initiate the request 106 from the computing device 120a. In response to receiving the request 106, the server 140 may determine whether the operations 154a contain sensitive content that requires obfuscation. If the server 140 determines that any of these operations is classified as private or includes sensitive data (e.g., PII, proprietary algorithms), the server 140 may execute obfuscation algorithm 170 to protect the sensitive content. In this process, with respect to operation 154a, the server 140 (e.g., via the GNN algorithm 150) may identify the operation 154a from the database of operations 154 stored in the memory of the server 140 and extrapolate a set of code lines 230 associated with the operation 154a.

In some embodiments, extrapolating the code lines 230 associated with the operation 154a may include analyzing the source code 214 using code parsing, lexical analysis, and semantic analysis to break down the source code into smaller portions, such as functions, variables, and logic blocks, to identify the sub-operation of each portion. The server 140 (e.g., via the GNN algorithm 150) may use metadata associated with the operation 154a, such as function names, function definitions, input-output parameters, and data dependencies, to extract and determine the purpose and context of code lines 230. In response, the server 140 may extract metadata 164 of the operation 154a from the code lines 230 (based on the operational attributes 158 of the operation 154a), where the metadata 164 may represent the context, purpose, and description of the operation 154a. The metadata 164 may be represented in a binary format. The metadata 164 may include data that indicates a data sensitivity indicator for the associated operation 154a, where the data sensitivity indicator indicates the sensitivity level of the operation 154a. Thus, if the data sensitivity indicator is more than a threshold, the server 140 may determine that the operation 154a includes highly sensitive content and select a more complex obfuscation algorithm 170 to obfuscate the sensitive content, similar to that described in FIG. 1.

In some embodiments, the server 140 may utilize the DNA entity generating algorithm 160 to convert the metadata 164 into a DNA data structure 232, where the bit values of the metadata 164 are converted into the letters A, T, C, and G as a DNA nucleotide sequence. The DNA data structure 232 may correspond to a first DNA strand 240a that is in a single helical format which are inherently encrypted. For example, the server 140 may utilize the ADS codex 162 to generate the DNA strand 240a, similar to that described in FIG. 1.

In some embodiments, the server 140 may extrapolate that the code lines 230 include a data element 236 that is confidential information. For example, assume that the code lines 230 of operation 154a include a function that references a data element 238 as a variable named “document validation,” which is used to store and process potentially sensitive information about a document. Upon detecting the variable name, the server 140 (e.g., via the GNN algorithm 150) may cross-reference and compare the operation 154a with the classification metadata of previously identified private operations in the private cluster 222a to confirm whether the “document validation” variable is indeed flagged as sensitive. If the GNN algorithm 150 determines that the variable aligns with a known sensitive data pattern from the training dataset 156 and the operation classifications, the server 140 may classify the function that includes the “document validation” variable as private. In response, the server 140 may obfuscate the data element 238.

In some embodiments, the server 140 may execute the obfuscation algorithm 170 to obfuscate the original variable data element 238. For example, obfuscating the data element 238 may include encrypting the data element 238 into an anonymized token or a decrypted format, such as a string of hashed values. In the same or another example, obfuscating the data element 238 may include substituting the data element with pseudo data, such as a string of Xs.

In some embodiments, the server 140 may determine a portion 234 of the DNA data structure 232 that corresponds to the data element 238 and obfuscate the portion 234 by executing the obfuscation algorithm 170 to encrypt the data portion 234 into an anonymized token or a decrypted format, such as a string of hashed values. In response, in some embodiments, the server 140 may generate a second DNA strand 240b by generating a complementary nucleotide sequence of the first DNA strand 240a along with the obfuscated portion 234. The second DNA strand 240b may include a transposed or complementary nucleotide sequence of the first DNA strand 240a with the obfuscated portion 234.

In some embodiments, after the server 140 generates the second DNA strand 240b, the server 140 may instantiate it in a simulated or virtual environment, such as a sandbox container, virtual machine that is triggered when a request 106 arrives, executes the operation 154a, and terminates it after its execution. For example, the server 140 may delete the files associated with the operation 154a. By confining the operation 154a's execution lifecycle to be temporary, the system facilitates that the sensitive data elements 238 is remained inaccessible outside of the lifecycle of the operation 154a.

In some embodiments, after initially encrypting the data element 238 and forming the first DNA strand 240a, the server 140 may perform an additional re-keying operation while generating the second DNA strand 240b. For example, the server 140 may use one encryption key to perform the initial obfuscation or hashing of the data portion 234, employ a second, distinct encryption key or cipher code to encrypt the newly created strand 240b. Thus, even if the first encryption key is compromised, the content within the second DNA strand 240b remains secure.

In some embodiments, the server 140 may transform the sequence of the second DNA strand 240b into a binary sequence 242. In some embodiments, in response to obfuscating the data element 238, the server 140 may transform the code that includes the code lines 230 with the obfuscated data element 238 into the binary sequence 242. The code in binary format (i.e., the binary sequence 242) may be executable by processors to perform the operation 154a. For example, the binary sequence 242 may be deployed and executed by processors to perform the operation 154a. The binary sequence 242 is a special purpose entity that is generated using GNN graphs and DNA computing directed to the request 106. The server 140 may deploy the code in binary sequence 242 to the computing device 120a. The code in the binary sequence 242 may be deployed to any other computing device 120 where the operation 154a is requested.

In some embodiments, the operations described herein may be triggered automatically in response to an electronic event signal that includes a specific pattern. In such embodiments, the server 140 may subscribe or register for specific intents or events within a message bus or event-streaming subscriber-publisher platform. Upon detecting an event signal that corresponds to a predefined pattern—such as “request for document-generation operation”—the server 140 may automatically instantiate the relevant operation in an isolated virtual environment, execute obfuscation to sensitive data elements 238 (if needed), and deploy the requested operation, in full or partially.

In some embodiments, upon identifying the sensitive content (in the data element 238) the server 140 may isolate and/or remove the data element 238 from being included in the binary sequence 242. Thus, in some embodiments, the network packet that includes the binary sequence 242 may not include the sensitive content.

### Method for Obfuscating Sensitive Content

FIG. 3 illustrates an example flowchart of a method 300 for obfuscating sensitive content from code lines 230, according to some embodiments. Modifications, additions, or omissions may be made to method 300. Method 300 may include more, fewer, or other operations. For example, operations may be performed in parallel or in any suitable order. While at times it is discussed that the system 100, computing devices 120, server 140, or components of any thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that when run by one or more processors (e.g., processor 142 of FIG. 1) may cause the one or more processors to perform operations 302-330.

At operation 302, the server 140 accesses a set of software applications 152a-c, similar to that described in FIGS. 1 and 2.

At operation 304, the server 140 selects a software application 152 from among the set of software applications 152a-c. The server 140 may iteratively select a software application 152 until no software application is left for evaluation.

At operation 306, the server 140 instantiates a replica 210 of the software application 152, similar to that described in FIGS. 1 and 2.

At operation 308, the server 140 determines whether to select another software application 152, similar to that described in FIGS. 1 and 2. The server 140 selects another software application 152 if at least one software application 152 is left for evaluation. If it is determined to select another software application 152, the method 300 returns to operation 304. Otherwise, the method 300 proceeds to operation 310.

At operation 310, the server 140 extrapolates, from the replica 210, a set of operational attributes 158 comprising data sensitivity levels, similar to that described in FIGS. 1 and 2.

At operation 312, the server 140 generates a graph structure 224 to represent the dependencies between the operations 154 based on the set of operation attributes 158, similar to that described in FIGS. 1 and 2.

At operation 314, the server 140 electronically receives, from a computing device 120a, a request 106 to deploy the first operation 154a on a software application 152, similar to that described in FIGS. 1 and 2.

At operation 316, the server 140 extrapolates a set of code lines 230 associated with the first operation 154a, similar to that described in FIGS. 1 and 2.

At operation 318, the server 140 extracts, from the code lines 230, metadata 164 associated with the first operation 154a, the metadata 164 comprising context associated with the first operation 154a, similar to that described in FIGS. 1 and 2.

At operation 320, the server 140 determines whether the first operation 154a comprises confidential information, similar to that described in FIGS. 1 and 2. If it is determined that the first operation 154a comprises confidential information, the method 300 proceeds to operation 322. Otherwise, the method 300 proceeds to operation 330.

At operation 322, the server 140 extrapolates, based on the metadata 164, that the set of code lines 230 comprises a data element 238 that is confidential information, similar to that described in FIGS. 1 and 2.

In some embodiments, the server 140 converts the metadata 164 into a DNA data structure 232 and generates first and second DNA strands, similar to that described in FIGS. 1 and 2.

At operation 324, the server 140 obfuscates the data element 238 comprising encrypting the data element, similar to that described in FIGS. 1 and 2.

At operation 326, the server 140 transforms the code comprising the code lines 230 with the obfuscated data element 238 into a binary format, where the code in binary format is executable by a processor to perform the first operation 154a, similar to that described in FIGS. 1 and 2.

At operation 328, the server 140 deploys the code in the binary format to the computing device 120a, similar to that described in FIGS. 1 and 2.

At operation 330, the server 140 transforms the code comprising the code lines 230 into binary format, where the binary format is executable by a processor to perform the first operation 154a, similar to that described in FIGS. 1 and 2.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a first software application and a second software application, wherein the first software application and the second software application share a first operation; and
a processor operably coupled to the memory, and configured to:
instantiate a first emulated replica of the first software application;
instantiate a second emulated replica of the second software application;
extrapolate, from the first emulated replica, a first set of operational attributes comprising a first set of data sensitivity levels, wherein:
each of the first set of data sensitivity levels is associated with a respective operation within the first emulated replica;
the first operation is associated with a first data sensitivity level;
the first data sensitivity level is more than a threshold level indicating that the first operation comprises confidential information;
extrapolate, from the second emulated replica, a second set of operational attributes comprising a second set of data sensitivity levels, wherein each of the second set of data sensitivity levels is associated with a respective operation within the second emulated replica;
electronically receive, from a computing device, a request to deploy the first operation on a third software application;
in response to electronically receiving the request:
extrapolate a set of code lines associated with the first operation;
extract, from the set of code lines based at least in part upon the first set of operational attributes and the second set of operational attributes, metadata associated with the first operation, the metadata comprising context associated with the first operation;
extrapolate, based at least in part upon the metadata, that the set of code lines comprises a data element that is the confidential information;
modify the data element by encrypting the data element into a string of hashed values;
transform code comprising the set of code lines with the modified data element into binary format, wherein the code in the binary format is executable by the processor to perform the first operation; and
deploy the code in the binary format to the computing device from which the request is received.

2. The system of claim 1, wherein the first set of operational attributes further comprises at least one of:
dependencies among a first set of operations associated with the first emulated replica;
a data flow that indicates a logical path traversed by data through the first operation; or
a communication protocol to communicate with other applications, wherein the communication protocol comprises an Application Programming Interface (API) protocol.

3. The system of claim 1, wherein modifying the data element further comprises substituting the data element with pseudo data.

4. The system of claim 1, wherein the second set of operational attributes further comprises at least one of:
dependencies among a second set of operations associated with the second emulated replica;
a data flow that indicates a logical path traversed by data through the first operation; or
a communication protocol to communicate with other applications, wherein the communication protocol comprises an Application Programming Interface (API) protocol.

5. The system of claim 1, wherein the processor is further configured to:
generate a graph structure comprising nodes connected via edges, wherein:
each node represents an individual operation within at least one of the first emulated replica or the second emulated replica; and
a given pair of nodes is connected via a respective edge that represents a relationship between the given pair of nodes;
analyze the graph structure to identify a subgraph that indicates the first operation and one or more dependent operations; and
utilize the graph structure in extracting the metadata from the first operation.

6. The system of claim 1, wherein the metadata further comprises a data sensitivity indicator that indicates the first data sensitivity level associated with the first operation.

7. The system of claim 1, wherein instantiating the first emulated replica of the first software application comprises
accessing source code associated with the first software application; and
executing the source code.

8. A method comprising:
instantiating a first emulated replica of a first software application;
instantiating a second emulated replica of a second software application, wherein the first software application and the second software application share a first operation;
extrapolating, from the first emulated replica, a first set of operational attributes comprising a first set of data sensitivity levels, wherein:
each of the first set of data sensitivity levels is associated with a respective operation within the first emulated replica;
the first operation is associated with a first data sensitivity level;
the first data sensitivity level is more than a threshold level indicating that the first operation comprises confidential information;
extrapolating, from the second emulated replica, a second set of operational attributes comprising a second set of data sensitivity levels, wherein each of the second set of data sensitivity levels is associated with a respective operation within the second emulated replica;
electronically receiving, from a computing device, a request to deploy the first operation on a third software application;
in response to electronically receiving the request:
extrapolating a set of code lines associated with the first operation;
extracting, from the set of code lines based at least in part upon the first set of operational attributes and the second set of operational attributes, metadata associated with the first operation, the metadata comprising context associated with the first operation;
extrapolating, based at least in part upon the metadata, that the set of code lines comprises a data element that is the confidential information;
modifying the data element by encrypting the data element into a string of hashed values;
transforming code comprising the set of code lines with the modified data element into binary format, wherein the code in the binary format is executable by a processor to perform the first operation; and
deploying the code in the binary format to the computing device from which the request is received.

9. The method of claim 8, wherein the first set of operational attributes further comprises at least one of:
dependencies among a first set of operations associated with the first emulated replica;
a data flow that indicates a logical path traversed by data through the first operation; or
a communication protocol to communicate with other applications, wherein the communication protocol comprises an Application Programming Interface (API) protocol.

10. The method of claim 8, wherein modifying the data element further comprises substituting the data element with pseudo data.

11. The method of claim 8, wherein the second set of operational attributes further comprises at least one of:
dependencies among a second set of operations associated with the second emulated replica;
a data flow that indicates a logical path traversed by data through the first operation; or
a communication protocol to communicate with other applications, wherein the communication protocol comprises an Application Programming Interface (API) protocol.

12. The method of claim 8, further comprising:
generating a graph structure comprising nodes connected via edges, wherein:
each node represents an individual operation within at least one of the first emulated replica or the second emulated replica; and
a given pair of nodes is connected via a respective edge that represents a relationship between the given pair of nodes;
analyzing the graph structure to identify a subgraph that indicates the first operation and one or more dependent operations; and
utilizing the graph structure in extracting the metadata from the first operation.

13. The method of claim 8, wherein the metadata further comprises a data sensitivity indicator that indicates the first data sensitivity level associated with the first operation.

14. The method of claim 8, wherein instantiating the first emulated replica of the first software application comprises
accessing source code associated with the first software application; and
executing the source code.

15. A non-transitory computer-readable medium storing instructions that when executed by a processor, cause the processor to:
instantiate a first emulated replica of a first software application;
instantiate a second emulated replica of a second software application, wherein the first software application and the second software application share a first operation;
extrapolate, from the first emulated replica, a first set of operational attributes comprising a first set of data sensitivity levels, wherein:
each of the first set of data sensitivity levels is associated with a respective operation within the first emulated replica;
the first operation is associated with a first data sensitivity level;
the first data sensitivity level is more than a threshold level indicating that the first operation comprises confidential information;
extrapolate, from the second emulated replica, a second set of operational attributes comprising a second set of data sensitivity levels, wherein each of the second set of data sensitivity levels is associated with a respective operation within the second emulated replica;
electronically receive, from a computing device, a request to deploy the first operation on a third software application;
in response to electronically receiving the request:
extrapolate a set of code lines associated with the first operation;
extract, from the set of code lines based at least in part upon the first set of operational attributes and the second set of operational attributes, metadata associated with the first operation, the metadata comprising context associated with the first operation;
extrapolate, based at least in part upon the metadata, that the set of code lines comprises a data element that is the confidential information;
modify the data element by encrypting the data element into a string of hashed values;
transform code comprising the set of code lines with the modified data element into binary format, wherein the code in the binary format is executable by the processor to perform the first operation; and
deploy the code in the binary format to the computing device from which the request is received.

16. The non-transitory computer-readable medium of claim 15, wherein the first set of operational attributes further comprises at least one of:
dependencies among a first set of operations associated with the first emulated replica;
a data flow that indicates a logical path traversed by data through the first operation; or
a communication protocol to communicate with other applications, wherein the communication protocol comprises an Application Programming Interface (API) protocol.

17. The non-transitory computer-readable medium of claim 15, wherein modifying the data element further comprises substituting the data element with pseudo data.

18. The non-transitory computer-readable medium of claim 15, wherein the second set of operational attributes further comprises at least one of:
dependencies among a second set of operations associated with the second emulated replica;
a data flow that indicates a logical path traversed by data through the first operation; or
a communication protocol to communicate with other applications, wherein the communication protocol comprises an Application Programming Interface (API) protocol.

19. The non-transitory computer-readable medium of claim 15, wherein the instructions further cause the processor to:
generate a graph structure comprising nodes connected via edges, wherein:
each node represents an individual operation within at least one of the first emulated replica or the second emulated replica; and
a given pair of nodes is connected via a respective edge that represents a relationship between the given pair of nodes;
analyze the graph structure to identify a subgraph that indicates the first operation and one or more dependent operations; and
utilize the graph structure in extracting the metadata from the first operation.

20. The non-transitory computer-readable medium of claim 15, wherein the metadata further comprises a data sensitivity indicator that indicates the first data sensitivity level associated with the first operation.
